(19) United States
(12) Patent Application Publication
(10) Pub. No.: US 2006/0184434 A1
(43) Pub. Date: Aug. 17, 2006

(54) Warranty claim preparation system

(76) Inventor: John F Schickler, ROCHESTER, NY (US)

Correspondence Address: BROWN & MICHAELS, PC;400 M & T BANK BUILDING, 118 NORTH TIOGA ST, ITHACA, NY, 14850, US

(21) Appl. No.: 10/501,973

(22) PCT Filed: Jan. 14, 2003
(86) PCT No.: PCT/US03/01029

§ 371 Date: Jul. 15, 2004

(51) Int. Cl. G06Q 40/00; G06F 7/00; G06F 17/00

(52) U.S. Cl. 705/35; 707/100

(57) ABSTRACT

This warranty claim preparation system for use with a computer relies on a comprehensive computer database and a versatile program to streamline warranty claim preparation, processing and tracking. The computer accessible database lists all vehicles on which warranty claims could be prepared for a user, all vehicle systems for each vehicle, all parts for each vehicle system, the original equipment manufacturer's standard repair time allowed for repair for each such part, and the proper failure and cause codes required by the original equipment manufacturer. It also contains the original equipment manufacturer's standard form for a warranty claim. The computer program provides means for accessing and processing information from the aforesaid database. Using a computer to access said information, it can provide a listing of vehicle systems for a particular vehicle listed in the database when the user indicates a particular vehicle, provide a listing of vehicle parts in that system when the user indicates a particular system, provide the original equipment manufacturer's standard repair time allowed for repair when the user indicates a particular part, and provide the original equipment manufacturer's proper failure and cause codes when the user indicates a particular part. Finally, it can prepare a work summary and a warranty claim on the original equipment manufacturer's standard form based on the aforesaid information.

This application claims the benefit of U.S. Provisional Application No. 60/348,832, filed on 15 Jan. 2002, which provisional application is incorporated by reference herein.

### TECHNICAL FIELD

This invention relates to document completion systems, in particular, warranty claim form completion systems.

### BACKGROUND OF THE INVENTION

Anyone who prepares original equipment manufacturer (“OEM”) warranty claims for vehicles faces an extensive amount of time and work to prepare and track claims. Typically, this will require the preparer to:

1. Find the OEM part numbers for a particular vehicle using its vehicle identification number (“VIN”);

2. determine the OEM standard repair time (“SRT”) allowance for the repair;

3. apply the SRT codes required by the OEM;

4. apply the proper failure and cause codes required by the OEM;

5. prepare a report in a standard format with ability to add comments and explanations; and

6. maintain a record of the filed claim and track payment status.

Thus, there exists a definite need for systems that will facilitate the preparation of such warranty claims and alleviate the time, financial burden and waste of man-hours occasioned by this necessary duty. Unfortunately, current systems are completely unavailable and/or deficient. In particular, there is no system that is able to find OEM part numbers by VIN, apply SRT codes required by the OEM, and apply the proper failure and cause codes required by the OEM. These deficiencies render all current systems unnecessarily labor intensive as these steps cannot be performed in an automated expedited manner. Instead, the preparer must often laboriously search for the necessary information by combing through reams and volumes of reference material.

### SUMMARY OF THE INVENTION

The warranty claim presentation system of my invention provides the ability to automatically accomplish all of the above-referenced needs in a few minutes. Thus, it is capable in most cases of: Finding the OEM part numbers for a particular vehicle using its vehicle identification number (“VIN”); determining the OEM standard repair time (“SRT”) allowance for the repair; applying the SRT codes required by the OEM; applying the proper failure and cause codes required by the OEM; preparing a report in a standard format with ability to add comments and explanations; and maintaining a record of the filed claim and track payment status. This is accomplished by the universal electronic linkage system of my invention, which automatically matches associated parts, labor allowances and manufacturer's codes. For warranty, the parts must be the equivalent to those installed in the vehicle when it was manufactured. These are referenced by VIN and then linked to applicable warranty codes in the specially designed tables of my warranty claim presentation system. There are 27 different tables used. Using the system of my invention, combined with the preparation of custom databases of VIN-based parts and labor information, eliminates the drudgery and wasted time of using the many references necessary for filing warranty claims. The improved speed and accuracy of claim preparation results in prompt submission of claims and reduction of rejections for improper claim preparation.

### DESCRIPTION OF THE DRAWINGS

FIG. 1 illustrates an initial sample screen for my invention providing icons for three possible search options.

FIG. 2 illustrates a sample screen reached upon selecting the Parts & Labor Generator from FIG. 1.

FIG. 3 illustrates a sample screen reached upon selecting a particular vehicle system from the sample screen illustrated in FIG. 2.

FIG. 4 illustrates a sample screen with parts per application description window.

FIG. 5 illustrates a sample screen with labor operations per application description window.

FIG. 6 illustrates a sample screen for a work summary.

FIG. 7 illustrates a sample screen for a work summary.

FIG. 8 illustrates a sample screen for a repair date.

FIG. 9 illustrates a sample screen for damage reason selection.

FIG. 10 illustrates a sample screen providing the full Labor Summary, complete with OEM Damage and Cause Codes, SRT Code, Description and Allowed Hours.

FIG. 11 illustrates a sample screen for a work summary.

FIG. 12 illustrates a sample screen for a completed Work Summary, ready for Electronic Warranty Claim form preparation with exactly the correct information required by the OEM.

FIG. 13 illustrates a sample screen for saving a work summary.

FIG. 14 illustrates a sample screen wherein all of the critical information and codes have been posted to the Warranty Claim form, ready for submission.

FIG. 15 illustrates a sample screen providing all Bills of Material for the vehicle.

FIG. 16 illustrates a sample screen showing all OEM parts for a Bill of Material.

FIG. 17 illustrates a sample screen showing all OEM parts for a Bill of Material.

FIG. 18 illustrates a table/sample screen showing all OEM parts for a Bill of Material.

FIG. 19 illustrates a sample screen for a direct part number search.

FIG. 20 illustrates a sample screen for entering a serial number.

FIG. 21 illustrates a sample screen used in a direct part number search.

FIG. 22 illustrates a sample screen used in cross-referencing a part number as part of a direct part number search.

FIG. 23 illustrates a sample screen used in finding a Bill of Material from a part number.

FIG. 24 illustrates a sample screen used in finding a Bill of Material from a part number.

FIG. 25 illustrates a sample screen used in finding a Bill of Material from a part number.

FIG. 26 illustrates a sample screen for a completed work summary.

FIG. 27 illustrates a sample screen for a completed work summary

### DESCRIPTION OF THE INVENTION

In order to practice my invention, it is first necessary to compile (at the minimum) a computer accessible database listing all vehicles on which warranty claims could be prepared for a user, all parts for each vehicle so listed, the original equipment manufacturer's standard repair time allowed for repair for each such part, the proper failure and cause codes required by the original equipment manufacturer for each such part, and the original equipment manufacturer's standard form for a warranty claim for that part. Various other features and information can be added to this database and is described in more detail below.

In addition to this database, my warranty claim preparation system relies on the use of a computer program for accessing and processing information from the aforesaid database. This program provides (at a minimum) a listing of vehicle parts for a particular vehicle listed in the database when the user indicates a particular vehicle in the database, provides the original equipment manufacturer's standard repair time allowed for repair when the user indicates a particular part, provides the original equipment manufacturer's proper failure and cause codes when the user indicates a particular part, and prepares a warranty claim on the original equipment manufacturer's standard form for a warranty claim based on the aforesaid information. Preferably, and in order to facilitate the operation of my system, a single code number is used in the database to denote each part and the original equipment manufacturer's standard repair time for that part. This code number is used by the computer program to, among other things, link these to the vehicle system for the part, the proper failure and cause codes required by the original equipment manufacturer for the part, the original equipment manufacturer's standard form for a warranty claim for that part, and bills of material for the vehicle containing that part.

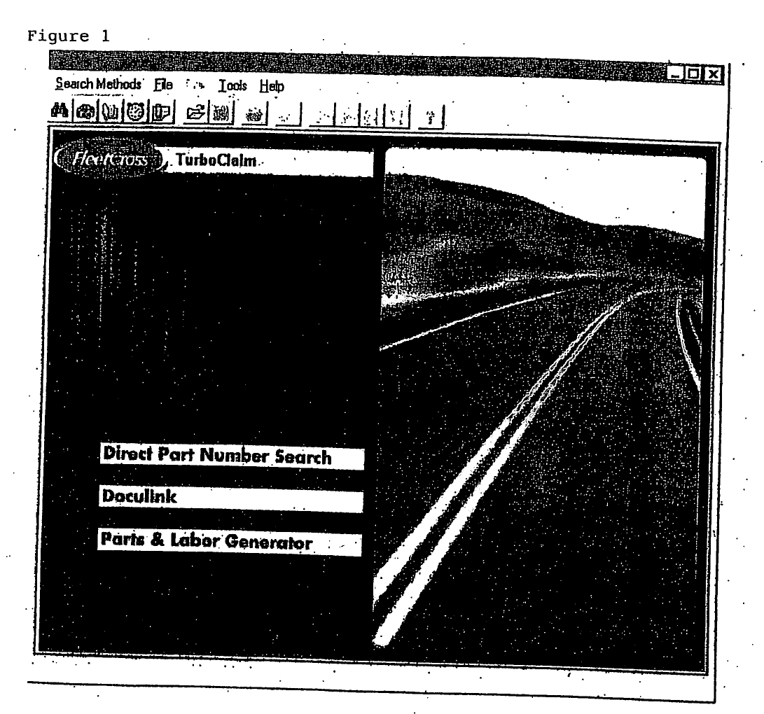

As illustrated in the accompanying drawing figures and outlined below, my warranty claim preparation system is simple to use and so flexible that it covers many different needs faced by warranty preparation personnel. It allows three electronically linked methods of obtaining and posting warranty information:
Direct Part Number Search is used when a part number is known and the matching labor allowances and codes are needed.
Doculink is used to find bills of material with their part number listings and then match them to labor allowances and codes.
Parts & Labor Generator is used to look up part numbers by descriptions, along with their labor allowances and codes.
   (A sample screen with icons for the foregoing search options is illustrated in FIG. 1).

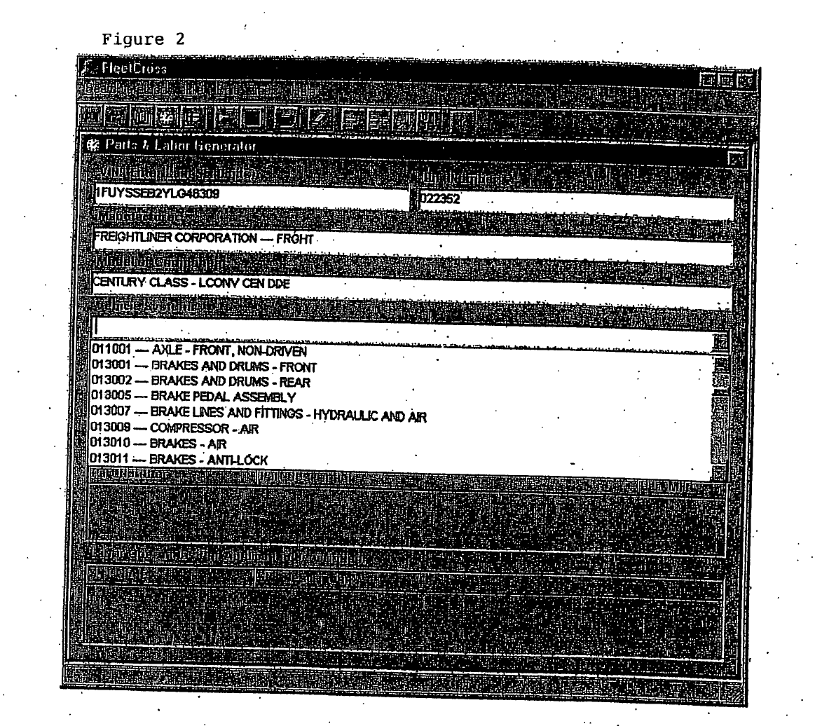

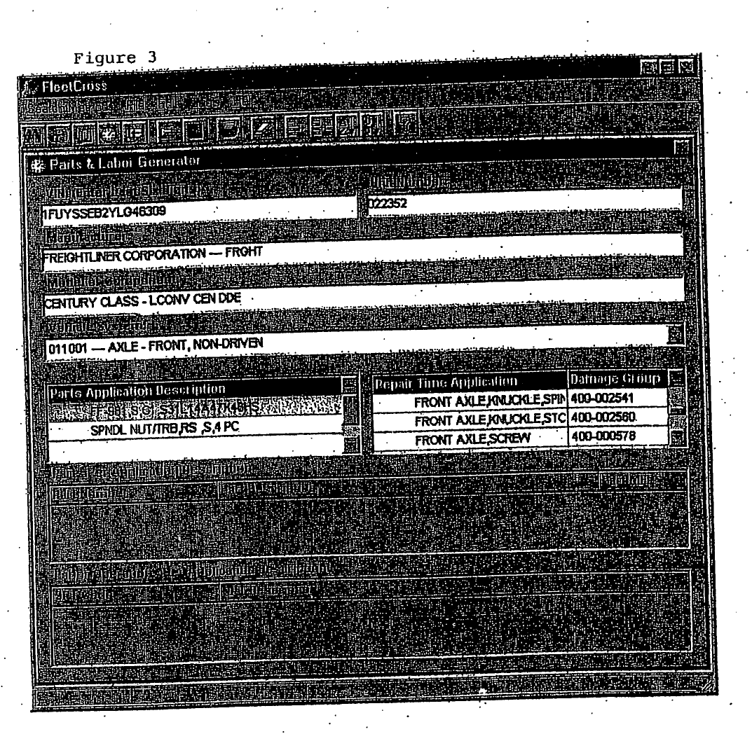

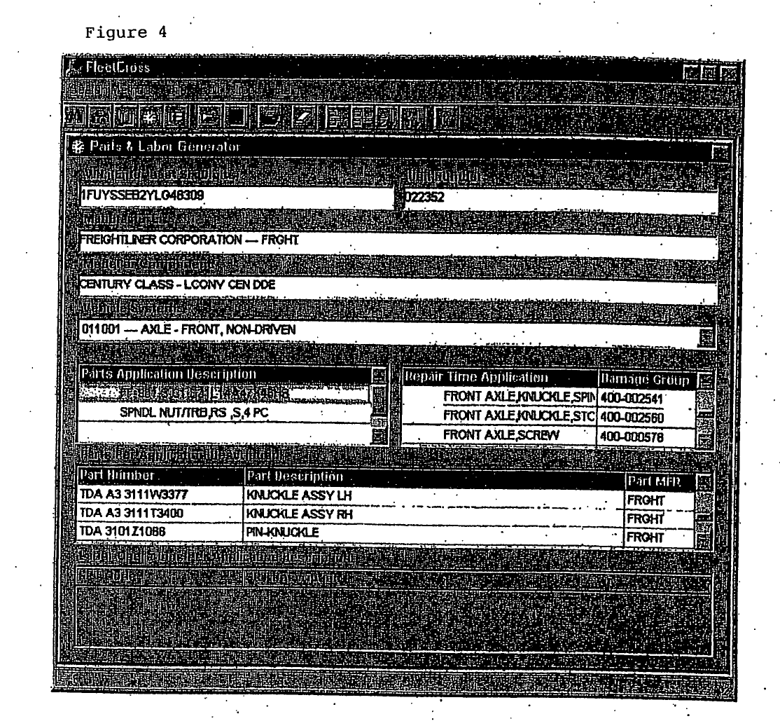

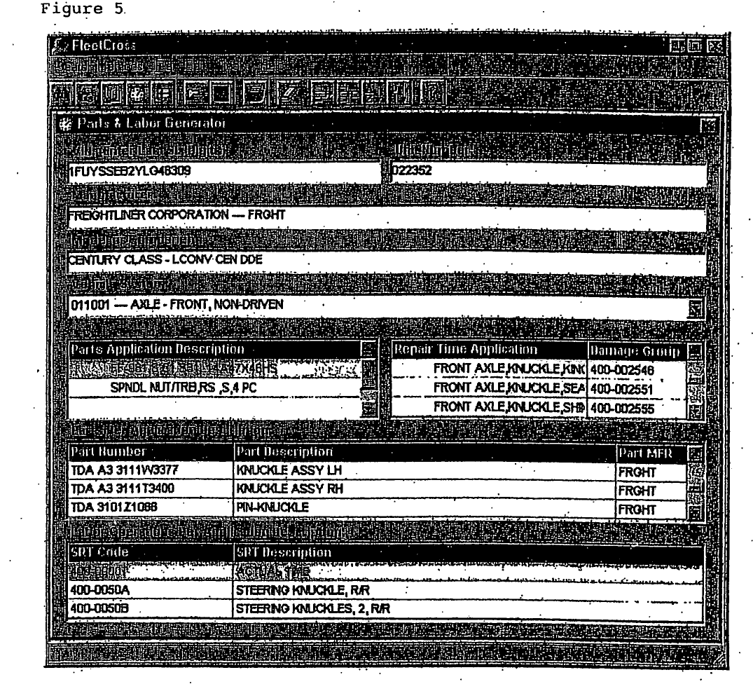

Vehicles are indexed in the database by vehicle identification number (VIN) or a user's Unit Number. In order to find parts and labor by VIN or Unit Number in the Parts & Labor Generator, the user will left click on Parts & Labor Generator. This will bring up the basic sample screen illustrated in FIG. 2. The user would then key in the last eight digits of the VIN or the digits of the unit number and press Enter. The vehicle will automatically be described with vehicle systems listed. Thus, the user can then scroll down the list or enter the first three digits in Vehicle System and select one. For example, a left click on “011001—AXLE-FRONT, NON DRIVEN” will bring up the sample screen/table illustrated in FIG. 3. The user can then scroll the Parts Application Description choices on the left, and the Repair Time Application choices on the right. The user could then, e.g., left click on “FF-981, S, C1.S31L14A47X46HS”. This would bring up the sample screen/table illustrated in FIG. 4. In the Parts Per Application Description window will appear the KNUCKLE ASSY part numbers and descriptions that are specific to the VIN or Unit Number. The user can now scroll to and left click the matching Repair Time Application, which is “FRONT AXLE, KNUCKLE, SPINDLE”. This will bring up the sample screen/table illustrated in FIG. 5.

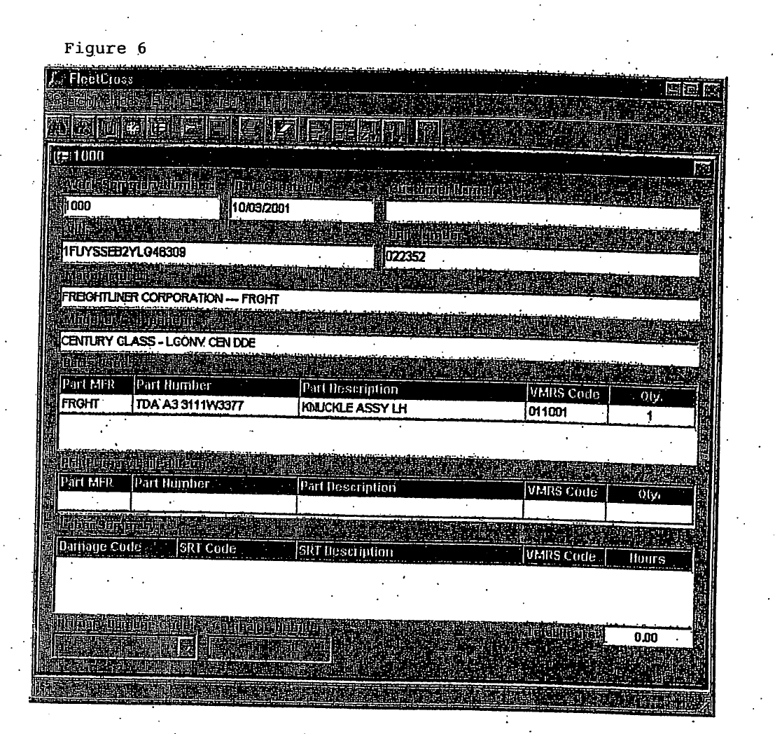

In the Labor Operations Per Application Description window appear the OEM SRT (Standard Repair Time) codes and descriptions. Note that they are different from the Damage Group Codes above. The user will want to post the Part Number and Labor Operations to a Work Summary, carrying along all information necessary for the warranty claim. Starting with parts, the user can perform a right click on, e.g., the Part Number TDA A3 31 11W3377 and a left click on “Post to Parts Used”. This will bring up the sample screen illustrated in FIG. 6. Now the user can post parts and labor selections to a work summary. Here the OEM Part Number TDA A3 3111W3377 has been posted, along with its OEM Description. The Work Summary is fully editable, except for Primary Failed Item. Explanations can be added if desired.

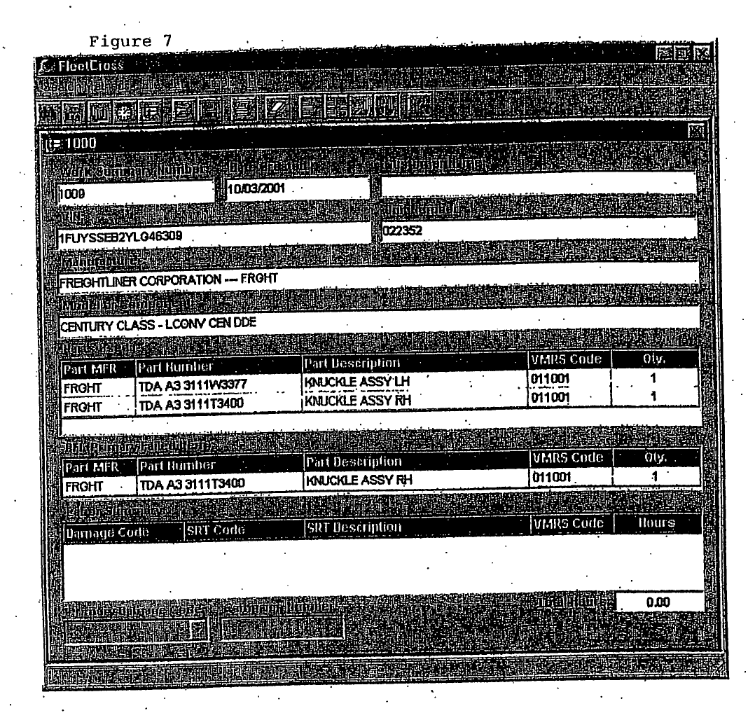

Now the user could return to PLG (clock icon) with a left click, then right click on the second Part Number TDA. A3 3111T3400. Left click on “Post To Parts Used and Primary Failed Item”. In FIG. 7 the RIGHT HAND. KNUCKLE ASSEMBLY has also been posted to the Work Summary and has also been identified as the Primary Failed Item.

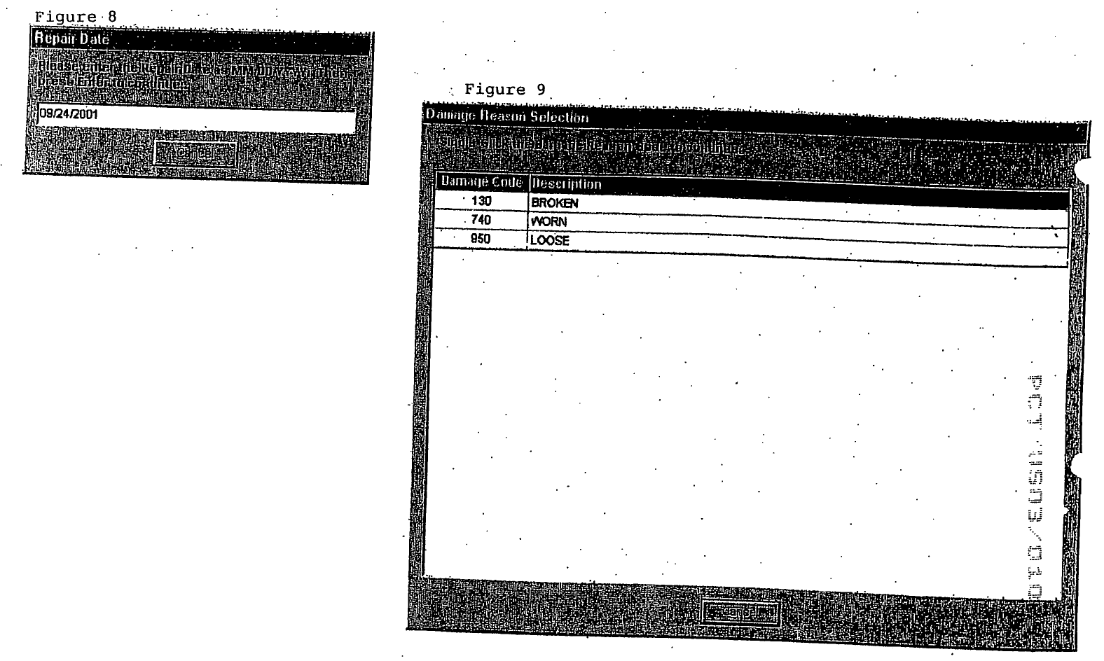

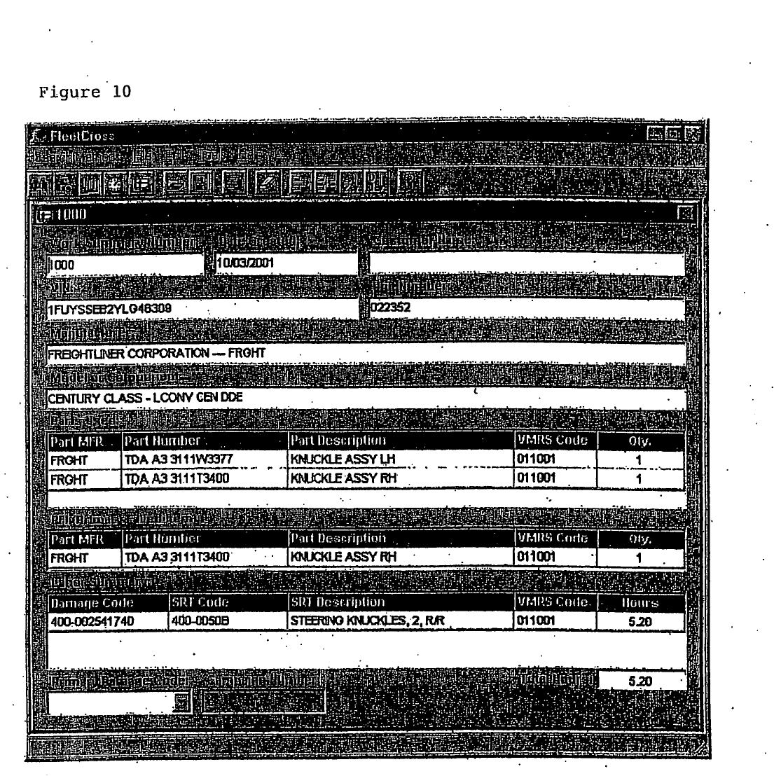

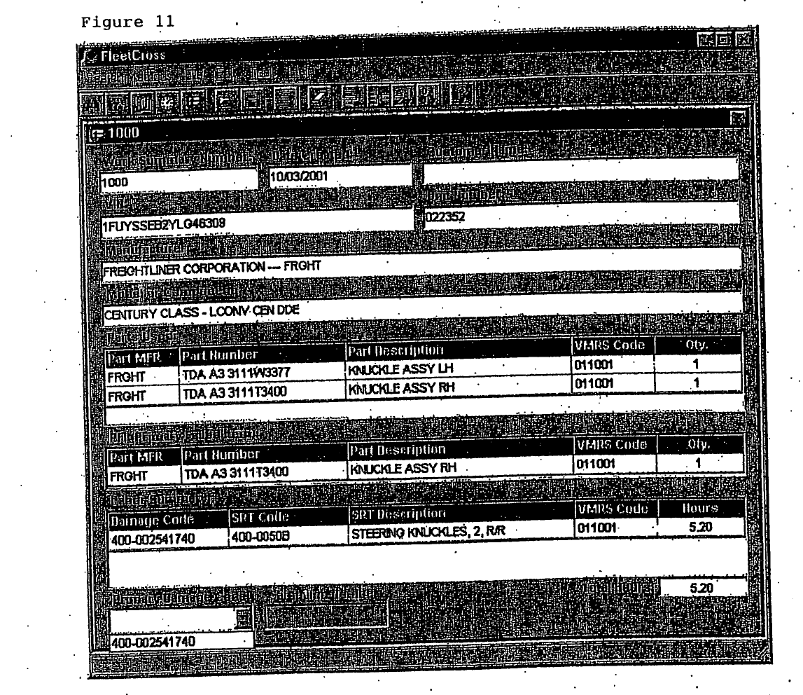

Now the user can return again to PLG (clock icon) to post the labor. The user can right click on OEM SRT Code 400-0050B for R/R of TWO STEERING KNUCKES, and left click on “Post to Labor Summary”. The sample screen/table illustrated in FIG. 8 may appear, requesting entry of the date of repair in the format shown. (Warranty claim allowances are sensitive to date of repair—my system is intended to deal with this requirement). The user can press Enter after keying in the date. After this, the screen illustrated in FIG. 9 may appear, requesting definition of a Cause or Damage Reason Code. (This is also generally required in a warranty claim). The user can then left click on, e.g., selection 740. It will automatically be applied to the end of the Damage Code. This leads to FIG. 10, the full Labor Summary, complete with OEM Damage and Cause Codes, SRT Code, Description and Allowed Hours. The user can then scroll the Primary Damage Code window and left click to post the appropriate code, as illustrated in FIG. 11. (This is another piece of essential information). Also note that “campaigns” (required field repairs) are also comprehended by the system.

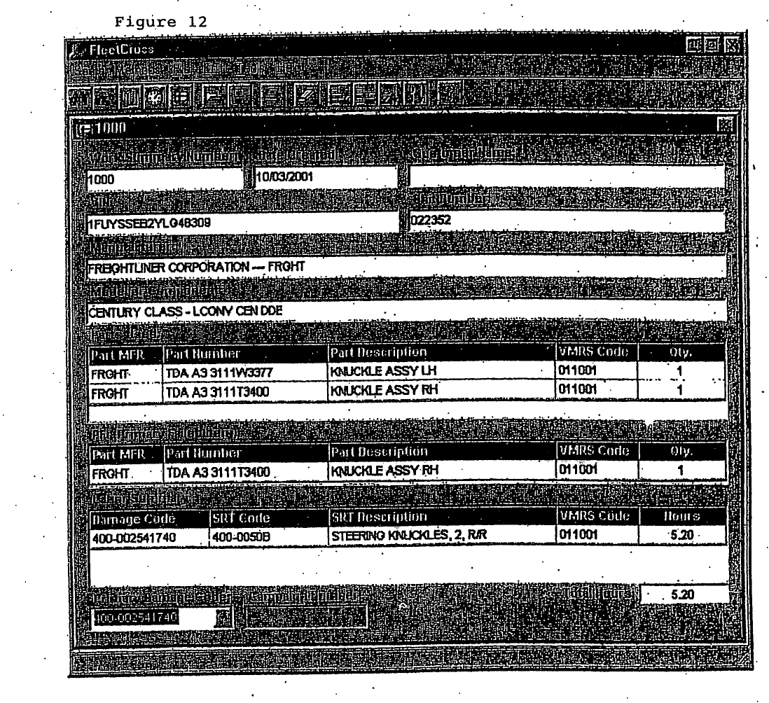

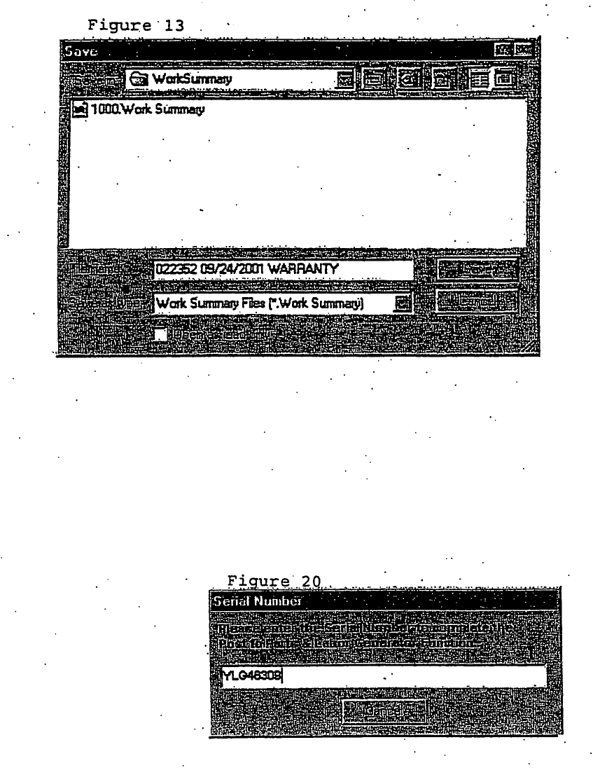

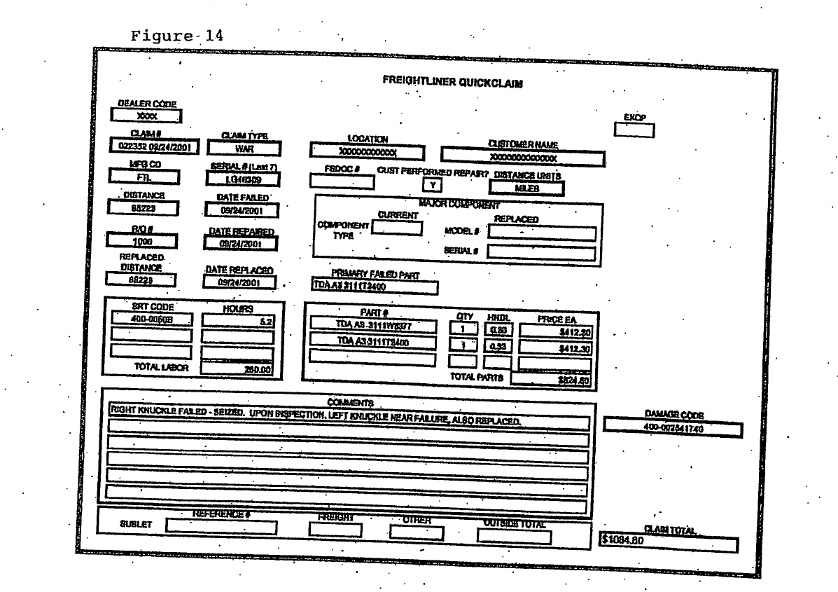

Finally, FIG. 12 illustrates the completed Work Summary, ready for Electronic Warranty Claim form preparation with exactly correct information required by the OEM. The user can now left click the folder icon to create a record of this Work Summary. This leads to the sample screen/table illustrated in FIG. 13. Here a file has been created entitled “022352 Sep. 24, 2001 WARRANTY” which can be saved and researched at any time to check warranty claim status and to look at a claim history by VIN or Unit Number. The tracking of claim status requires that this file be prepared. This is accomplished automatically in my system. Finally, FIG. 14 illustrates all of the critical information and codes posted to the Warranty Claim form, ready for submission. My system automatically posts the critical claim information onto the manufacturer's form, just as is required by each different manufacturer. Each claim form is different.

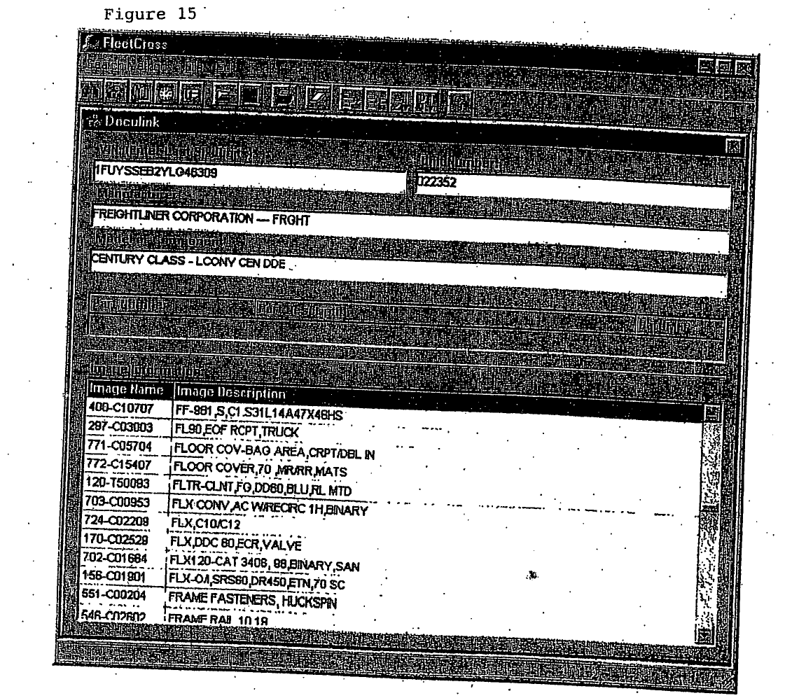

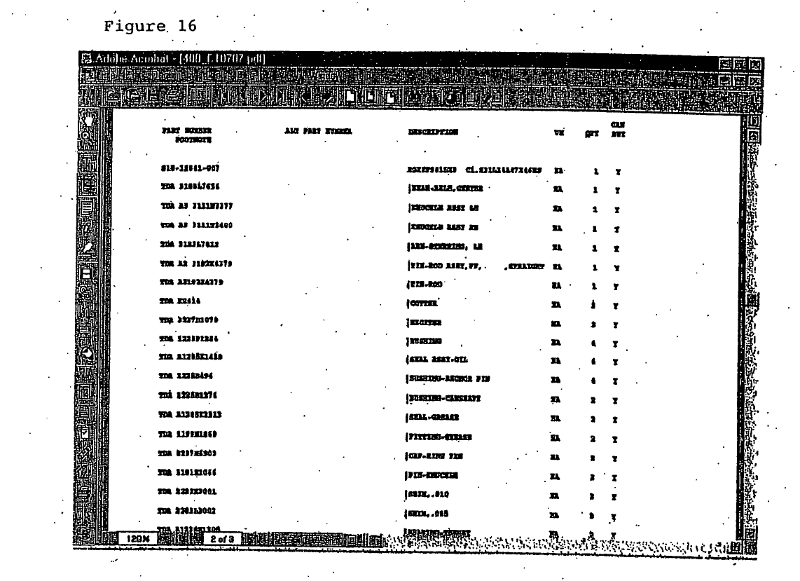

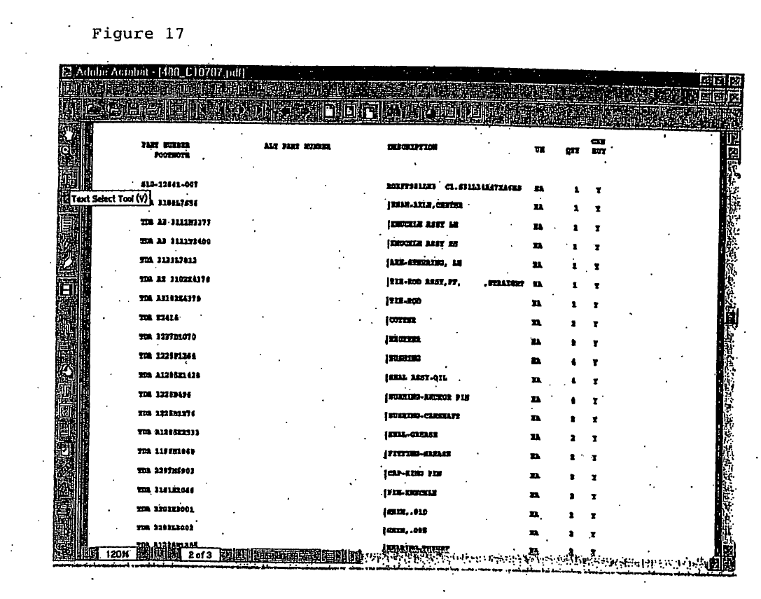

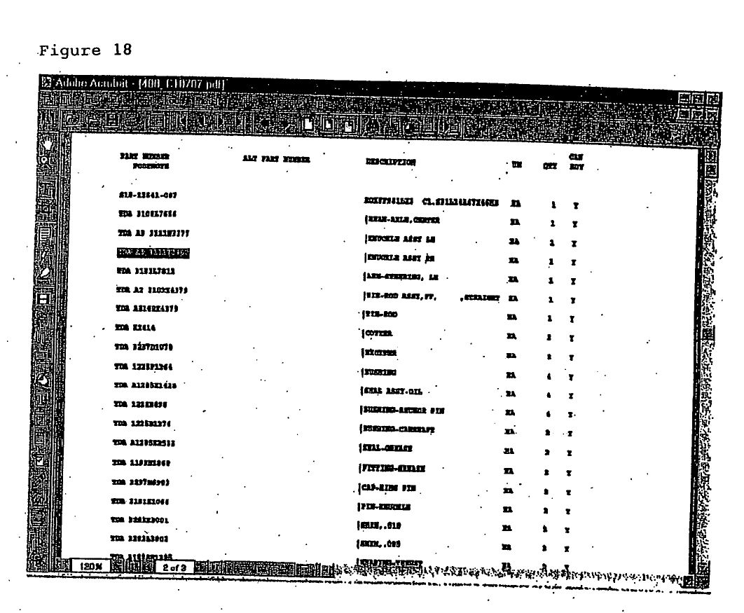

If the user wishes to use Doculink to view all Bills of Material line settings, he can left click the camera icon to open Doculink, key in the VIN or Unit Number and press Enter. This leads to the sample screen/table illustrated in FIG. 15, which lists all Bills of Material for the vehicle. If the user were to, e.g., double click the image name 400-C10707 for the Front Axle he would reach the sample screen/table illustrated in FIG. 16. Here is the Line Setting for Bill of Material 400-C10707, used on Truck Serial Number LG46309. All of the OEM parts content is shown. Now the user will want to find the matching Labor Allowances and Codes. To do this he can left click on the “Text Select Tool” icon in the left tool bar. Doing so makes the Line Setting part numbers searchable. The user can then highlight part number TDA A3 311 1T3400 as illustrated in FIG. 18, right click on it and then left click “Copy”.

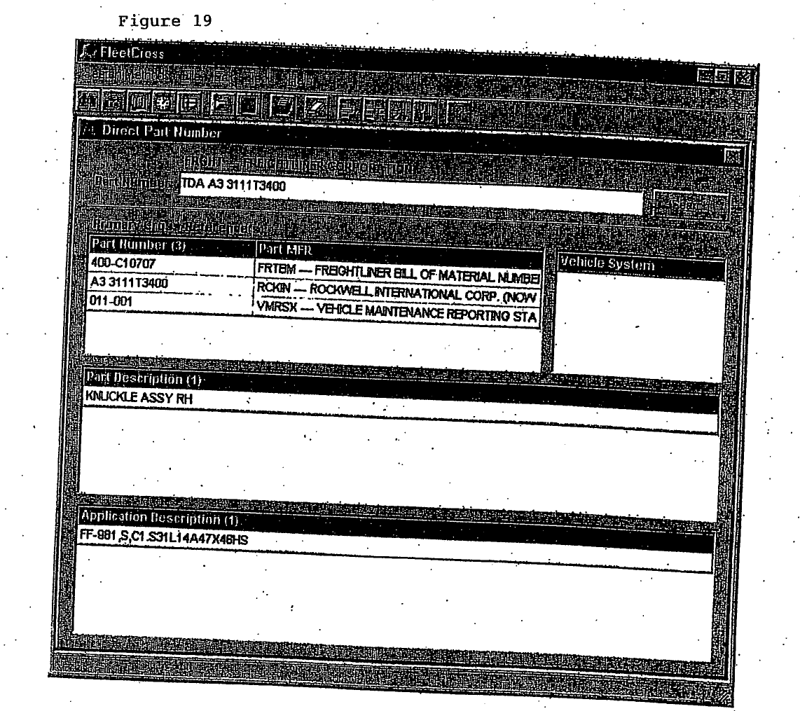

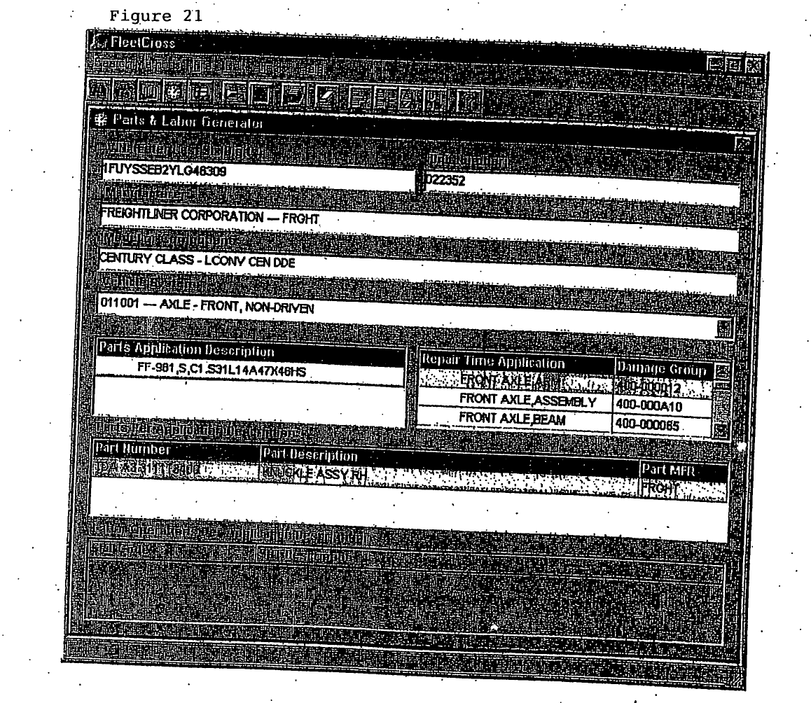

If the user wishes to initiate a direct part number search, he can do so by a left click on the binoculars icon. Right click and paste or key in, e.g., the part number TDA A3 311 1T3400 and left click on Search. This leads to the sample screen/table illustrated in FIG. 19, where we see the part number, cross reference (Rockwell-Meritor), bill of material number and its Vehicle Maintenance Reporting Systems (VMRS) Code, 011001. In order to find its Labor Allowance, right click on FRGHT and left click on “Post to Parts and Labor Generator”. (This is a reverse of starting with a VIN to find a part number, but it leads to the same result as shown in FIG. 21). The sample screen/table illustrated in FIG. 20 will appear, requesting the vehicle serial number. The user can key it in and press Enter, leading to the sample screen/table illustrated in FIG. 21. Now the system has automatically posted part number TDA A3 3111T3400 into PLG and presented the Repair Time Application choices with it. From there the user can proceed in the same manner discussed with respect to FIG. 4 and set forth in its accompanying text.

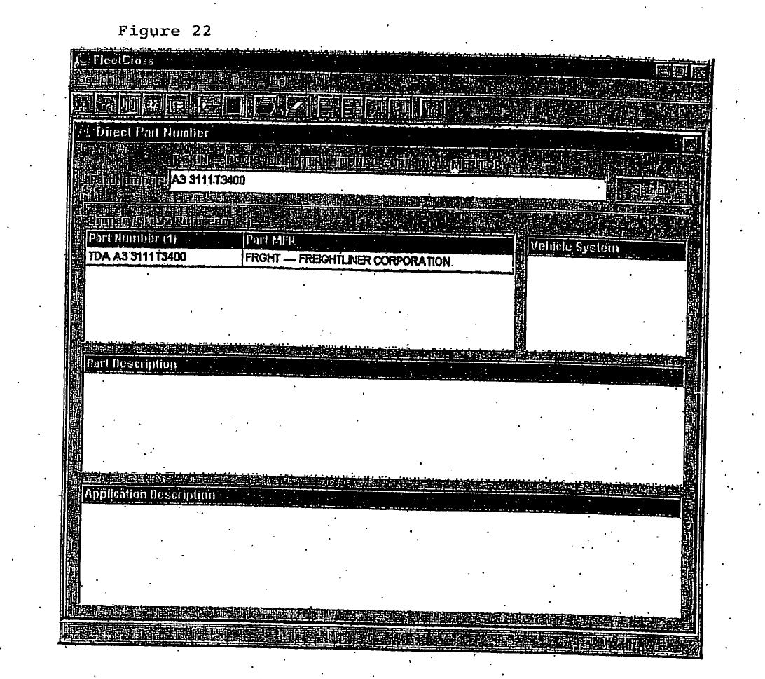

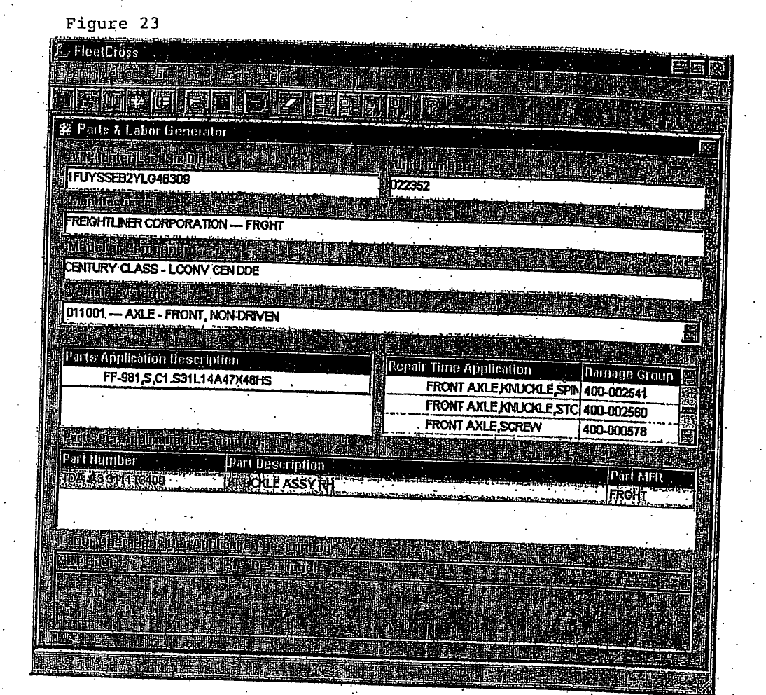

The user can also cross-reference a part number in a direct part search. Sometimes a part number appears on a part as a supplier number, not as an OEM. The database further includes supplier numbers for parts, and the program can operate fully using supplier numbers as well as original equipment manufacturer's numbers. Here, as illustrated in FIG. 22, removal of the “TDA” prefix from the Freightliner part number and a search in the Direct Part Number Search reveals that the part is made by Rockwell (Meritor). The Rockwell number might appear on the part, but the Freightliner number is needed for the warranty claim. The user can right click on the TDA part number and then left click on “Post To Parts Used”.

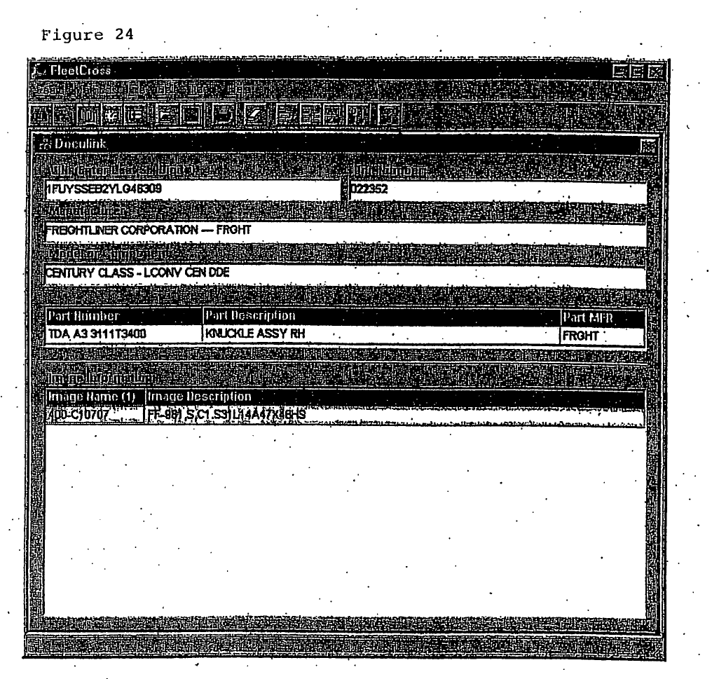

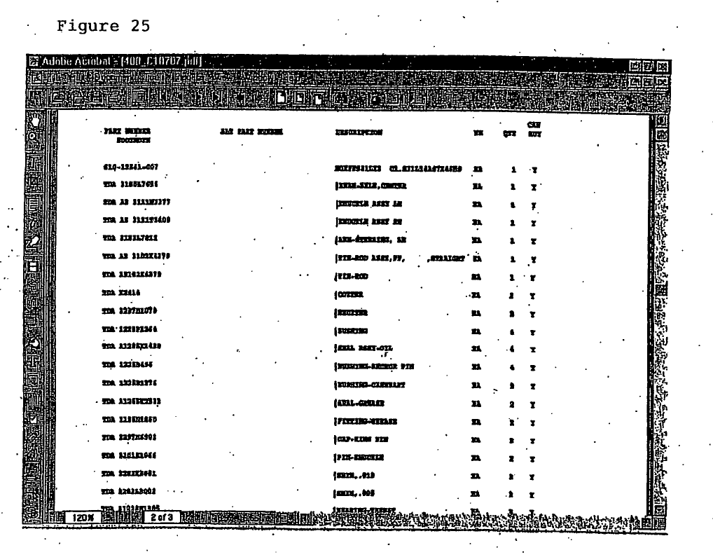

Likewise, the user can find a bill of material from a part number. (See FIG. 23). Here the drill-down in PLG has, e.g., found part number TDA A3 3111T3400. All of the parts associated with it can be automatically found in its Bills of Material. To do so, the user can right click on the part number, then left click on “Post to “Doculink”. (See, also. FIG. 24). Here is a screen showing the Bill of Material “Image Name” for part number TDA A3 3111T3400. The user can double left click on the Image Name, leading the complete Bill of Material for part number TDA A3 3111T3400 and all associated parts to appear. (See FIG. 25). The user can now proceed to find the Labor in the same manner discussed with respect to FIG. 16 and set forth in its accompanying text.

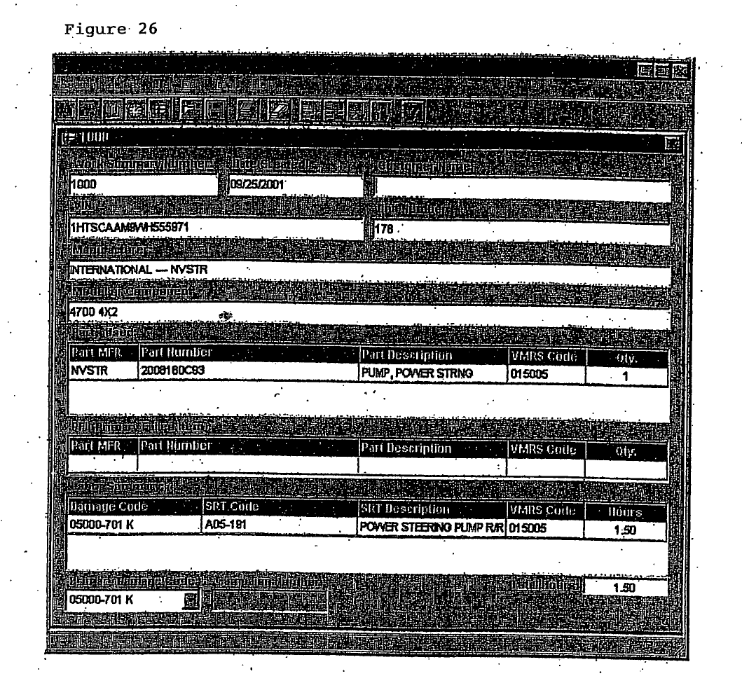

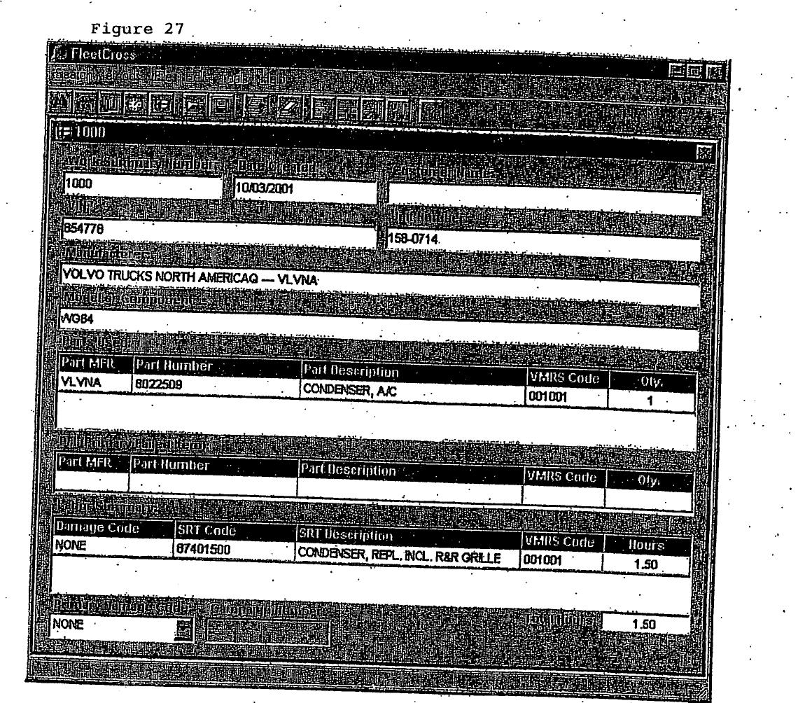

My invention can be used to obtain and record the proper warranty claim information for many OEM makes. For example, FIG. 26 sets forth a completed Work Summary for an International truck, while FIG. 27 sets forth a Work Summary for a Volvo WG64.

In summary, my invention allows the user to obtain and record valid OEM complaint, cause and correction information and codes for filing warranty claims by:
Searching VIN or Unit Numbers to obtain both parts and matching labor information and codes.
Searching known part numbers to find bills of material of associated part numbers and matching labor information and codes by VIN.
Posting information which can be directly entered onto a claim form.
Cross-referencing of part numbers, casting numbers, etc. as they appear on supplier's parts to OEM part numbers.
Filing information for claim follow-up and historical records.
Covering “All-Makes” of vehicles with one referencing system.
   However, it is to be understood that the inventive concepts underlying and embodied in my invention can be incorporated in different forms so that the general concepts described in the preceding description is not to be superseded by the particularity of the attached drawings. Various alterations, modifications, and/or additions can be made without departing from the spirit or ambit of the invention.

1. A method, comprising:
compiling a computer accessible database, said database listing all vehicles on which warranty claims could be prepared for a user, listing all parts for each vehicle so listed, listing the original equipment manufacturers standard repair time allowed for repair for each such part, listing the proper failure and cause codes required by the original equipment manufacturer for each such part, and containing the original equipment manufacturer's standard form for a warranty claim; and
providing a computer program for accessing and processing information from the aforesaid database, the program providing a listing of vehicle parts for a particular vehicle listed in the database when the user indicates a particular vehicle in the database, providing the original equipment manufacturer's standard repair time allowed for repair when the user indicates a particular part, providing the original equipment manufacturer's proper failure and cause codes when the user indicates a particular part, and preparing a warranty claim on the original equipment manufacturer's standard form for a warranty claim based on the aforesaid information.

2. A method as set forth in claim 1, wherein the vehicles are indexed in the database using some portion of each vehicle's official vehicle identification number such that the user indicates a particular vehicle by said portion.

3. A method as set forth in claim 1, wherein the vehicles are indexed in the database using a vehicle identification number assigned by the user such that the user indicates a particular vehicle by said number.

4. A method as set forth in claim 1, wherein vehicle parts for each vehicle are indexed in the database by vehicle systems, the program provides a listing of such systems when the user indicates a particular vehicle, and the program provides a listing of parts in a vehicle system when the user designates a particular vehicle system.

5. A method as set forth in claim 1, wherein the computer program further prepares a work summary based on the aforesaid information.

6. A method as set forth in claim 1, wherein the program can save the warranty claim and the information used in developing the warranty claim in a computer file for future access, research and tracking.

7. A method as set forth in claim 1, wherein said database further includes a listing of bills of materials for the vehicles and a listing of the parts set forth in each of said bills of materials for the vehicles, and said program provides a listing of bills of material for a vehicle when the user indicates that vehicle, provides parts for a particular bill of materials when the user indicates that bill of materials, provides the original equipment manufacturer's standard repair time allowed for repair when the user indicates a particular part, provides the original equipment manufacturer's proper failure and cause codes when the user indicates a particular part, and can prepare a warranty claim on the original equipment manufacturer's standard form for a warranty claim based on the aforesaid information.

8. A method as set forth in claim 1, wherein said database further includes supplier numbers for parts, and said program can operate fully using supplier numbers as well as original equipment manufacturer's numbers.

9. A method as set forth in claim 1, wherein a single code number is used in the database to denote each part and the original equipment manufacturers standard repair time for that part, and is used by the computer program to link these to the proper failure and cause codes required by the original equipment manufacturer for the part, and the original equipment manufacturer's standard form for a warranty claim for that part.

10. A method, comprising:
compiling a computer accessible database, said database listing all vehicles on which warranty claims could be prepared for a user, listing all vehicle systems for each vehicle so listed, listing all parts for each vehicle system so listed, listing the original equipment manufacturers standard repair time allowed for repair for each such part, listing the proper failure and cause codes required by the original equipment manufacturer for each such part, and containing the original equipment manufacturer's standard form for a warranty claim; and
providing a computer program for accessing and processing information from the aforesaid database, the program providing a listing of vehicle systems for a particular vehicle listed in the database when the user indicates a particular vehicle in the database, providing a listing of vehicle parts in that system when the user indicates a particular system, providing the original equipment manufacturer's standard repair time allowed for repair when the user indicates a particular part, providing the original equipment manufacturer's proper failure and cause codes when the user indicates a particular part, preparing a work summary based on the aforesaid information, and preparing a warranty claim on the original equipment manufacturer's standard form for a warranty claim based on the aforesaid information.

11. A method as set forth in claim 10, wherein the vehicles are indexed in the database using some portion of each vehicle's official vehicle identification number such that the user indicates a particular vehicle by said portion.

12. A method as set forth in claim 10, wherein the vehicles are indexed in the database using a vehicle identification number assigned by the user such that the user indicates a particular vehicle by said number.

13. A method as set forth in claim 10, wherein the program can save the warranty claim and the information used in developing the warranty claim in a computer file for future access and research.

14. A method as set forth in claim 10, wherein said database further includes a listing of bills of materials for the vehicles and a listing of the parts set forth in each of said bills of materials for the vehicles, and said program provides a listing of bills of material for a vehicle when the user indicates that vehicle, provides parts for a particular bill of materials when the user indicates that bill of materials, provides the original equipment manufacturer's standard repair time allowed for repair when the user indicates a particular part, provides the original equipment manufacturer's proper failure and cause codes when the user indicates a particular part, and can prepare a warranty claim on the original equipment manufacturer's standard form for a warranty claim based on the aforesaid information.

15. A method as set forth in claim 10, wherein said database further includes supplier numbers for parts, and said program can operate fully using supplier numbers as well as original equipment manufacturer's numbers.

16. A method as set forth in claim 10, wherein a single code number is used in the database to denote each part and the original equipment manufacturers standard repair time for that part, and is used by the computer program to link these to the vehicle system for the part, the proper failure and cause codes required by the original equipment manufacturer for the part, and the original equipment manufacturer's standard form for a warranty claim for that part.

17. A method, comprising:
compiling a computer accessible database, said database listing all vehicles on which warranty claims could be prepared for a user, listing all vehicle systems for each vehicle so listed, listing all parts for each vehicle system so listed, listing the original equipment manufacturers standard repair time allowed for repair for each such part, listing the proper failure and cause codes required by the original equipment manufacturer for each such part, containing the original equipment manufacturer's standard form for a warranty claim, listing all bills of materials for the vehicles, and listing all parts set forth in each of said bills of materials for the vehicles; and
providing a computer program for accessing and processing information from the aforesaid database, the program providing a listing of vehicle systems for a particular vehicle listed in the database when the user indicates a particular vehicle in the database, providing a listing of vehicle parts in that system when the user indicates a particular system, providing a listing of bills of material for a vehicle when the user indicates that vehicle, providing a listing of parts for a particular bill of materials when the user indicates that bill of materials, providing the original equipment manufacturer's standard repair time allowed for repair when the user indicates a particular part, providing the original equipment manufacturer's proper failure and cause codes when the user indicates a particular part, preparing a work summary based on the aforesaid information, and preparing a warranty claim on the original equipment manufacturer's standard form for a warranty claim based on the aforesaid information.

18. A method as set forth in claim 17, wherein the vehicles are indexed in the database using some portion of each vehicle's official vehicle identification number such that the user indicates a particular vehicle by said portion.

19. A method as set forth in claim 17, wherein the vehicles are indexed in the database using a vehicle identification number assigned by the user such that the user indicates a particular vehicle by said number.

20. A method as set forth in claim 17, wherein the program can save the warranty claim and the information used in developing the warranty claim in a computer file for future access and research.

21. A method as set forth in claim 17, wherein said database further includes supplier numbers for parts, and said program can operate fully using supplier numbers as well as original equipment manufacturer's numbers.

22. A method as set forth in claim 17, wherein a single code number is used in the database to denote each part and the original equipment manufacturers standard repair time for that part, and is used by the computer program to link these to the vehicle system for the part, the proper failure and cause codes required by the original equipment manufacturer for the part, the original equipment manufacturer's standard form for a warranty claim for that part, and bills of material for the vehicle containing that part.

23. A method, comprising:
compiling a computer accessible database containing information on a group of vehicles, said information including a listing of the vehicles, a listing of parts used in the assemblage of each such vehicle, and items of information including images related to each such part, where each vehicle is linked to the list of parts used in the assemblage of that vehicle, and where each part is linked to items of information related to that part via a single Code linked to that part and to the items of information related to that part; and
providing a computer program for accessing and processing information from the aforesaid database, the program allowing the user to search said database and obtain linked database information.

24. A method as described in claim 23, above, wherein said items of information include at least one of original equipment manufacturers' standard repair times allowed for repair of each part, proper failure and cause codes required by the original equipment manufacturer for each part, standard forms for warranty claims for the original equipment manufacturers of each part, official vehicle identification numbers for each vehicle of the group, user assigned vehicle identification numbers for each vehicle of the group, vehicle systems for each part, bills of materials for each vehicle of the group, supplier numbers for all parts on all bills of materials for any vehicle of the group, vehicle systems for each vehicle of the group, vehicle parts for each vehicle system, and images of any of the aforesaid items.

25. A method as set forth in claim 23, wherein the program can provide a listing of vehicle parts for a particular vehicle listed in the database when the user indicates a particular vehicle in the database.

26. A method as set forth in claim 23, wherein the program can provide the original equipment manufacturer's standard repair time allowed for repair when the user indicates a particular part.

27. A method as set forth in claim 23, wherein the program can provide the original equipment manufacturer's proper failure and cause codes when the user indicates a particular part.

28. A method as set forth in claim 23, wherein the program can prepare a warranty claim on the original equipment manufacturers' standard form for a warranty claim.

29. A method as set forth in claim 23, wherein the vehicles are indexed in the database using some portion of each vehicle's official vehicle identification number such that the user indicates a particular vehicle by said portion.

30. A method as set forth in claim 23, wherein the vehicles are indexed in the database using a vehicle identification number assigned by the user such that the user indicates a particular vehicle by said number.

31. A method as set forth in claim 23, wherein vehicle parts for each vehicle are indexed in the database by vehicle systems.

32. A method as set forth in claim 23, wherein the program can provide a listing of vehicle systems when the user designates a particular vehicle.

33. A method as set forth in claim 23, wherein the program can provide a listing of parts in a vehicle system when the user designates a particular vehicle system.

34. A method as set forth in claim 23, wherein the computer program can provide a work summary.

35. A method as set forth in claim 23, wherein the program can save a warranty claim and the information used in developing the warranty claim in a computer file for future access, research and tracking.

36. A method as set forth in claim 23, wherein said database includes a listing of bills of materials for the vehicles and a listing of the parts set forth in each of said bills of materials for the vehicles, and said program can provide a listing of bills of material for a vehicle when the user designates that vehicle.

37. A method as set forth in claim 23, wherein the program can provide parts for a particular bill of materials when the user indicates that bill of materials, can provide the original equipment manufacturer's standard repair time allowed for repair when the user indicates a particular part, can provide the original equipment manufacturer's proper failure and cause codes when the user indicates a particular part, and can prepare a warranty claim on the original equipment manufacturer's standard form for a warranty claim based on the aforesaid information.

38. A method as set forth in claim 23, wherein said database further includes supplier numbers for parts, and said program can operate fully using supplier numbers as well as original equipment manufacturer's numbers.

39. A method as set forth in claim 24, wherein the program can provide a listing of vehicle parts for a particular vehicle listed in the database when the user indicates a particular vehicle in the database.

40. A method as set forth in claim 24, wherein the program can provide the original equipment manufacturer's standard repair time allowed for repair when the user indicates a particular part.

41. A method as set forth in claim 24, wherein the program can provide the original equipment manufacturer's proper failure and cause codes when the user indicates a particular part.

42. A method as set forth in claim 24, wherein the program can prepare a warranty claim on the original equipment manufacturers' standard form for a warranty claim.

43. A method as set forth in claim 24, wherein the vehicles are indexed in the database using some portion of each vehicle's official vehicle identification number such that the user indicates a particular vehicle by said portion.

44. A method as set forth in claim 24, wherein the vehicles are indexed in the database using a vehicle identification number assigned by the user such that the user indicates a particular vehicle by said number.

45. A method as set forth in claim 24, wherein vehicle parts for each vehicle are indexed in the database by vehicle systems.

46. A method as set forth in claim 24, wherein the program can provide a listing of vehicle systems when the user designates a particular vehicle.

47. A method as set forth in claim 24, wherein the program can provide a listing of parts in a vehicle system when the user designates a particular vehicle system.

48. A method as set forth in claim 24, wherein the computer program can provide a work summary.

49. A method as set forth in claim 24, wherein the program can save a warranty claim and the information used in developing the warranty claim in a computer file for future access, research and tracking.

50. A method as set forth in claim 24, wherein said database includes a listing of bills of materials for the vehicles and a listing of the parts set forth in each of said bills of materials for the vehicles, and said program can provide a listing of bills of material for a vehicle when the user designates that vehicle.

51. A method as set forth in claim 24, wherein the program can provide parts for a particular bill of materials when the user indicates that bill of materials, can provide the original equipment manufacturer's standard repair time allowed for repair when the user indicates a particular part, can provide the original equipment manufacturer's proper failure and cause codes when the user indicates a particular part, and can prepare a warranty claim on the original equipment manufacturer's standard form for a warranty claim based on the aforesaid information.

52. A method as set forth in claim 24, wherein said database further includes supplier numbers for parts, and said program can operate fully using supplier numbers as well as original equipment manufacturer's numbers.

53. A method as set forth in claim 1, wherein the computer program automatically posts to a work summary based on the aforesaid information.

54. A method as set forth in claim 1, wherein the program can save warranty claim and work summary history information used in developing the warranty claim in a computer file for future access, research and tracking.

55. A method as set forth in claim 1, wherein said database further includes a listing and images of bills of materials for the vehicles and a listing and images of the parts set forth in each of said bills of materials for the vehicles, and wherein said program provides a listing of bills of material for a vehicle when the user indicates that vehicle, provides parts and images for a particular bill of materials when the user indicates that bill of materials, provides the original equipment manufacturer's standard repair time allowed for repair when the user indicates a particular part, provides the original equipment manufacturer's proper failure and cause codes when the user indicates a particular part, and can prepare a warranty claim on the original equipment manufacturer's standard form for a warranty claim based on the aforesaid information.

56. A method as set forth in claim 10, wherein the program can automatically post to and save the warranty claim and the work summary information used in developing the warranty claim in a computer file for future access and research.

57. A method as set forth in claim 23, wherein the computer program can provide a work summary, can provide a vehicle history file, and can link to another system for at least one of parts ordering and retrieval.

58. A method as set forth in claim 24, wherein the computer program can post to a work summary and vehicle history file.
